(19) United States
(12) Patent Application Publication
(10) Pub. No.: US 2017/0163781 A1
(43) Pub. Date: Jun. 8, 2017

(54) USER INTERFACE FOR CONTACTS MANAGEMENT AND COMMUNICATION

(71) Applicant: RAM RAMESH SESHAN, San Diego, CA (US)

(72) Inventor: RAM RAMESH SESHAN, San Diego, CA (US)

(21) Appl. No.: 15/296,036

(22) Filed: Oct. 18, 2016

Related U.S. Application Data
(60) Provisional application No. 62/264,466, filed on Dec. 8, 2015.

(51) Int. Cl. H04M 1/2745; H04W 4/12; G06F 3/16; G06F 3/0483; G06F 3/0488; G06F 3/0482; H04M 1/725; G06F 3/0481

(52) U.S. Cl. CPC H04M 1/27455; H04M 1/72583; H04W 4/12; G06F 3/04817; G06F 3/0483; G06F 3/04883; G06F 3/0482; G06F 3/167

(57) ABSTRACT

Methods and systems for contacts attribute extraction, management and communication for quick and easy selection of a contact from plurality of contacts to facilitate communication are described. A user interface provides for a convenient way to arrange contacts attribute for a specific purpose or a specific condition and extract such contacts conveniently and quickly in the course of communicating. The contacts are tagged with specific icon or picture buttons based on pre-selected attributes, such tagged contacts are displayed on across the home screen for simple use by users specifically elders or children for communication.

### FIELD OF THE INVENTION

The present invention generally relates to a user interface for contact attribute extraction and management for ease of communication and, more specifically, to methods and systems for quick and easy selection of a contact and its attributes from plurality of contacts to facilitate voice and text communication thereof.

### BACKGROUND OF THE INVENTION

A Smartphone is an important communication tool in people's daily lives. It has become an important communication bridge between people throughout the world. The Smartphone is rapidly becoming an essential electronic device for all voice and text-based communication.

The Smartphones have capability to store and organize a lot of contacts and also, many different communication modes have been achieved in last few years. In spite of these tremendous achievements in Smartphone design and capabilities, the way individual contacts are stored, managed and accessed for communication has not changed. This contact information is typically arranged in a contact terminal (also known as an address book) and can include name, address information, telephone numbers, and email addresses. Many of these contact terminal systems offer features such as speed dial, voice dial, and images to enhance the look and user experience. Contacts on a Smartphone are still stored as a list alphabetically sorted by the contact name. In contact terminals of Smartphone, the contacts are sorted by a fixed rule, e.g., first name or last name of the contacts or both. When the user searches for a contact, the contacts are traversed. The user may also input a searching condition, e.g., a first letter of a name. The contact terminal displays contacts matching with the searching condition. Thus, the contact may be found.

Further, a user has to individually inform related members such as relatives, friends, schoolmates, colleagues, business partners, customers and other individuals by sending changed contact information with a text message or by making a phone call whenever contact information or any other attribute of the contact is changed. Additionally, there is no easy way to automatically notify contacts when the phone number or any other contact attributes are changed.

Often, there are a plurality of contacts and the user is burdened with the task of entering and maintaining contact information for each contact in the contact terminal is a redundant task that is both time consuming and tedious.

At the same time, due to the wide and diverse nature of workgroups and relationships, a user meets a lot of people and thus causing creation of a lot of contacts that are shared and stored on Smartphone. However, the purposes and relationship of contacts shared in the device, or matters related to the various people is forgotten after some time. That is because modern life makes a person suffer a myriad of things, and the person cannot manage all the changes manually.

Most often these contacts are never backed-up on a regular basis. Hence, Smartphone users struggle to recover their important contacts along with their attributes when they lose their device or switch from one carrier to another.

Next, in modern communication system, calling and instant messaging has become a popular way of electronically communicating, in particular when using a Smartphone. People are constantly finding different ways to communicate both socially and professionally. The Internet has made communication easily accessible via internet calling and instant messaging applications. The profiles or presence information are often used to allow a user to view the current status of other contacts on the calling and instant messaging applications. For example, the presence information may show a contact is busy or available. While calling and instant messaging with contacts, a user and their contacts may be in different situations. For example, if the user is aware that a contact is busy, then the user may decide not to send a message to the contact. However, displaying whether a contact is busy or available may not provide the user with sufficient presence information to discern the situation of the contact. Also, none of applications provides ability to store and send frequently used messages with ease and further an emergency message to alert recipients before calling.

For example, making an emergency call to summon an ambulance could save a life. However, calling and instant messaging applications do not provide an easy way to make a call when needed. Paramedics, and emergency response personnel recommends creating emergency contact entries called ‘In Case of Emergency’ or ICE. However, seldom Smartphone users create such entries and even when there is such an entry, it may not be easily accessible during emergency situations. Even when such contacts are called at the time of need, there is no easy way to differentiate an ordinary call from an emergency call at the recipient's end.

Again, most of the time, people communicate across time-zones. Additionally, more people travel from one time-zone to another more frequently than before. However, Smartphone do not provide an easy way to indicate a user about the time-zone of a contact.

Therefore, using a Smartphone is getting very challenging for elders and children and those who are just interested in using it as a basic mobile device. The look and feel of a conventional phone has been replaced by large touch screen and apps that can do various activities very much like a personal computer. This paradigm shift is posing a challenge to millions who would like to continue using a Smartphone as a generic phone to make calls or send simple text messages to their loved ones and their caretakers.

On many Smartphones, users can tag a contact as ‘Favorite’ and select the one when needed. However, even this is challenging for many since it requires selecting the appropriate options available on the Smartphone requiring many selections.

To overcome the drawbacks, the present disclosure has evaluated and contemplated a variety of these and other functions to provide a user interface system with ease of managing contacts, using various attributes of the contacts and communicating in an effective manner that is centered about a user's preferred choice for arranging contacts in different groups and mode of communication along with many other beneficial functions.

### SUMMARY OF THE INVENTION

An object of the present invention is to provide a user interface for contact and its attributes management and communication systems and methods therein that substantially obviate one or more problems due to limitations and disadvantages of the related art.

In the present disclosure, a system and method for contacts management and communication is provided. In one implementation, a user interface for managing plurality of contacts and allowing communication between users, an icon or picture button referred as “chat button” that may be used to identify a user or contact, thereby conventional telephone numbers are eliminated. The chat button comprises a contact record including a profile picture and actual contact number with current status and time zone. When activated, a small time clock will be displayed on the chat button to indicate the time at the location of the user. This clock will be shown in 5 min interval and will update upon taping the refresh button. The user, for example, may arrange the contacts as per their preference in different form such as family, friend or business and further the user can communicate with other users in contact through the application. The chat button can be permanent or temporary and may be used for any number of purposes, such as family, friend or business, and more.

A user can create the chat button for each of the contacts which are displayed on the home tab screen display of the interface, therefore providing easy selection of a contact from plurality of contacts to facilitate voice and text communication thereof. In one implementation, the chat button is highly configurable. For example, a user can add identifiable information to the chat button, such as icon or pictures, titles, or the like to the chat button. A chat button conceals underlying contact information, showing only information chosen by a user. In one implementation, for example, the user can then make voice or text message with one-click reaching the contacts wherever in the world they may be.

The interface can provide the nature and identity of an inbound call or text message, can answer immediately, put an inbound call on hold, block inbound calls or messages, and/or send a custom response (e.g., instant text message as response).

The main object of the present invention is to provide a user interface for managing contacts and their attributes not limited to but amongst others like picture, location, current status, language preference, pre-recorded text and voice messages and communication thereof, by which contacts are arranged in such a manner that elders, children and other users can communicate with their loved ones/caretakers without accessing confusing Smartphone's native dialing app. The interface provides a simple, convenient way for arranging contacts for specific purpose or specific condition and extracted conveniently and quickly in the course of communicating from list of plurality of contacts. Also, provides an ability to create groups for more than two users for ease of communication in the group.

One aspect of the present invention provides a user interface for contact management and communication on mobile devices by elderly people. The user interface comprises a contact terminal for creating and arranging a plurality of contacts on a home tab screen display, a chat button for each of the contact may be created that may be used to identify a contact on the contact terminal, a communication button for ease of communication configured with the chat button for each contact, and a selectable control is provided on the home tab screen display. The selection of the control in a first context initiates a call toward the selected contact and the selection of the control in a second context initiates transmission of a textual message toward the selected contact.

The contact terminal can allow users to arrange their chat buttons into categories for convenient access to commonly used call buttons (e.g., family contacts, business contact, social contacts, etc.). In one implementation, a user can create a group chat button that includes a list of a plurality of other chat buttons. A group chat button allows a user to send a message or recorded voice message to all members in the group with a single click. Further, the user has an ability to send and receive the chat button image from the contacts.

Another aspect of the present invention provides a system for contact management and communication on mobile devices by elderly people. The system includes a memory, and a processor, coupled to the memory, adapted to receive a request to connect the mobile device to an application server. The system verifies an association between the normalized phone number and the user interface via a loop back verification message and authorize for the mobile device to communicate over the application server. Using the normalized phone number, a user may able to synchronize the contacts on a contact terminal that are also users of the application server. Further, configure a plurality of contacts in the contact terminal on home tab screen display, creates a chat button that may be used to identify a contact on the contact terminal. Further, a communication button for ease of communication is configured with the chat button for each contact. The mobile devices are Smartphone, a tablet PC, a iWatch or a personal computer, comprising a software application (App) that enables users to access to an application server by internet and to interact with other users belonging to the same application server that have been previously registered through a registration process. The plurality of contacts is registered and displayed on home tab screen display, further when a new user is registered, the chat button of registered user will automatically come-up with different color such as in blue color and also the Voice Over Internet Protocol (VOIP) calling over data network is automatically activated, and the user can set their preferences for ease of communication between VOIP calling and a native calling.

Further, the application provides an Elderly Mode features, during installation, a user will be prompted ‘Activate Elderly User Mode’. When confirmed, all the features tagged as Elderly Mode, will be activated. Users can always deactivate these in Settings. The Elderly Mode features include a tab display, the chat buttons will be grouped by chat button type such as Friends, Family, Business, Work, etc. The Elderly Mode features include “tap swipe” to go to next screen to avoid jiggling during swipe. The chat button is default and provides users with option to customize its size and shape to accommodate according to the size of display of the mobile device.

Further, most of the time, elders get lost in their Smartphone. Therefore, the application provides a user to make the application as default home application. When activated, the application will be launched automatically. Optionally, the application can also be made to come-up when user clicks the Home button.

Further, many elderly users have a difficult time setting the phone in speaker mode. Hence, adding a default speaker mode option can help the elderly. When the user makes a call, speaker mode will be switched automatically.

Further, the application provides auto population of profile image after changing the image, and also notifies and changes the chat button image of selected users. Further, the user can upload up to three avatar and tag separately to each image as for Friends, Family, and Professional.

Further, the application provides customized status for delivery and read confirmation in text based communication. For example: no status (Grey closed envelope), Delivered (Black closed envelope), Read Confirmation (Black open envelope). Further, in text based communication, a user can send Picture, Video, Voice Recording, Docs (Word/PDF).

Another aspect of the present invention combines the convenience of using a phone number with the application for use with the Internet and over data networks.

Another aspect of the present invention provides status of contacts even though they might be members of different voice networks. If a user changes their status, then all other contacts on the system may potentially receive the status update.

The system and methods are provided for conducting voice communications with real-time status notifications. In some aspects, a user is able to easily and quickly create and send text message to another user. Either or both users may receive real-time notifications of the status of the other user.

Another aspect of the present invention is that it organizes Smartphone contacts and their attributes in multiple groups such as relatives, friends, schoolmates, colleagues, business partners, customers, emergency and healthcare emergency; and specific icon or picture buttons are used for tagging a contact, thereby tagged contacts are displayed on across screen for simple use by the user tapping on the icon, specifically helping elders or children.

Another aspect of the present invention is that, the interface provides for individualized Smartphone for users who are interested in managing and communicating with their contacts to make calls and send text messages. In addition to that, it also provides contact sharing, number change notification, cloud backup, emergency tagging, and custom text messaging.

One other aspect of the present invention is that the interface provides for lots of additional functions such as: ability to switching from call mode to text mode with a gentle swipe of a communication button. Preferably the emergency contacts are arranged tagged in red icon or picture button for avoiding confusion; wherein, the ability to make an emergency call by double-taping an icon or picture button tagged as an emergency contact. Also, initiates an emergency text notification in addition placing a voice call. Users at the receiving end will be able to see the emergency text message before picking the call. The interface has ability to tag contacts for emergency to make a call to emergency personnel during need such as ability to make an emergency call to summon ambulance service. The emergency contacts are pre-tagged in emergency icon or picture button according to the country of origin and also a list of emergency numbers for all countries are pre-configured. The current location of the caller is retrieved and displayed to help notify emergency personnel. The emergency contacts are automatically or dynamically updated in case of any change in number and for new number. Before dialing to emergency number, the system asks user's confirmation to protect from any accidental tap of the emergency icon or picture.

One other aspect of the present invention is its ability to take minimal information from users to perform registration. The registration is done using Short Messaging Service (SMS) to fetch user's mobile number including country code and verify the mobile device to communicate over the application serve use of 6-digit alphanumeric key to uniquely match user registration with SMS message and direct network connectivity.

One other aspect of the present invention is its ability to notify other users in the event of a phone number change. i.e., the ability to receive number change notification from other users; and the ability to automatically change the contact number to the new number. Further, the user may notify selected contacts and the receiving user may update the changed number in the chat button.

One other aspect of the present invention is its ability to indicate the current time-zone of users i.e., easy way to indicate the time-zone of all contacts. Further, depending on the number of contacts, the size and layout of the icon or picture button will change. The Emergency icon or picture button could be named as SOS. The Emergency/SOS button can also be their medical alert button. An emergency chat button on each tab screen display to summon an emergency help that could save a life, where location of the user is automatically retrieved and automatically changes the emergency number based on the location or country the user is registered.

One other aspect of the present invention is the ability to tag contact for emergency to make a call to emergency personnel during need such as ability to make an emergency call to summon ambulance service. The emergency contacts are pre-tagged in emergency icon or picture button according to the country of origin and also a list of emergency numbers for all countries are pre-configured. The current location of the user is retrieved and displayed to help notify emergency personnel. The emergency contacts are automatically or dynamically updated in case of any change in number and for new number. Before dialing to emergency number, the system asks user's confirmation to protect from any accidental tap of the emergency chat button.

One other aspect of the present invention is its ability to view the current status of other contacts, as well as allows other contacts to view the current status of the user. Also, every user can customize the status with predefined text to be viewed by contacts.

One other aspect of the present invention is its ability to send pre-configured text messages to other users. In the same way, the user can create and save text message in many languages; and send pre-configured text messages to other users as required in text messaging.

One other aspect of the present invention is a user may be able to create a message (voice or text) in any language and schedule it for delivery at a specific date/time, also able to edit or rerecord the message at any time before the scheduled time.

One other aspect of the present invention is its ability to create a notification message such as “call-me-asap’ feature, which is notified to one or more users by tagged icon or picture button of the originator's.

One other aspect of the present invention is to automatically backup and manually back on the remote server of user related data such message, picture and other media. Also notify users when someone else recovers their backup.

One other aspect of the present invention is its ability to identify returning users of the system during registration; and accordingly inform and recover cloud backup of the returning user.

One other aspect of the present invention is to locate user mobile device by plotting the last known location on a Google map. This can be used for locating lost device, or monitor the movement of an elderly or a young user.

Further, advertisers can create chat buttons for promoting specific products, services or offerings. These chat buttons can be published to group chat buttons that that contain highly targeted prospects for such services. Advertiser chat buttons can interact with the business systems of the advertisers, through the chat button messaging, voice capabilities, or direct system-to-system interactions over a network such as the Internet.

### BRIEF DESCRIPTION OF THE DRAWINGS

The invention will be described with reference to the following drawings of which:

FIG. 1 is a block diagram illustrates an example implementation of a system, on which embodiments of the present invention may be employed;

FIG. 2 is a block diagram in one implementation for performing the system or methods of the present invention;

FIG. 3 illustrates an example implementation of a system for managing chat button assigned to a plurality of users;

FIG. 4 illustrates of an example of user contacts sequence and communication options menu on home screen of a user interface, on which embodiments of the present invention may be employed;

FIG. 5 illustrates a mobile device displaying a user interface, on which embodiments of the present invention may be employed;

FIG. 6 is a flowchart representation of the operations for registering a mobile device with the system of the present invention;

FIG. 7 is a flowchart representation of the operations for arranging and tagging contacts, on which embodiments of the present invention may be employed;

FIG. 8a is a flowchart representation of a method of changing phone number; on which embodiments of the present invention may be employed;

FIG. 8b is a flowchart representation of a method of number update notification to other contacts;

FIG. 9 illustrates an exemplary system useful in implementations of the described technology;

FIGS. 10a-10j are screenshots of an example of a user interface of the system, on which embodiments of the present invention may be employed.

The drawing figures do not limit the present invention to the specific embodiments disclosed and described herein. The drawings are not necessarily to scale; emphasis instead being placed upon clearly illustrating the principles of the invention.

### DETAILED DESCRIPTION OF THE INVENTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

In some embodiments of the invention, a system, user interface and methods are provided for conducting voice and text based communications with real-time status notifications. In different embodiments, one or more of multiple complementary features are implemented, such as voice recording, instant messaging, dynamic real-time notification and time zone notification to a user.

Embodiments of the invention are implemented within a communication environment in which, voice, text, images, and/or other electronic information are exchanged via data communication channels conforming to an IEEE 802.11 standard (e.g., Wi-Fi® connections). In these embodiments, rather than relying upon traditional wireless voice communication channels that provide limited support for transmission of instant or real-time communications other than live voice conversations, the data communication channels allow unconstrained exchange of virtually all types of communications on a mobile device.

The present invention provides a system that can be used to manage plurality of contacts, their attributes and to facilitate communication on a mobile device e.g., Smartphone. The system provides a user interface; the interface is arranged to activate from a user's “home button” of the Smartphone. This provides simple, convenient way for arranging contacts for specific purpose or specific condition and tagged information is extracted conveniently and quickly in the course of communicating from a list of plurality of contacts.

The user interface when activated shall display a home tab screen display containing one or more speed dial tiles (buttons) representing various contacts the user would like to communicate more often. By touching any of the tiles/buttons, the user shall be able to call or text the individual.

Creating of contacts on home tab screen display is done by selecting one or more contacts from user contact list and tagging the contacts with an icon or picture, and further arranging in different groups such as relatives, friends, schoolmates, colleagues, business partners, customers, emergency and healthcare emergency. The icon or picture are selected from default images or can be browsed from other media libraries.

Illustrative embodiments of the invention are described as they may be implemented as part of a one-on-one communication session via communication button, but may also be applicable to group communication sessions (e.g., group chat).

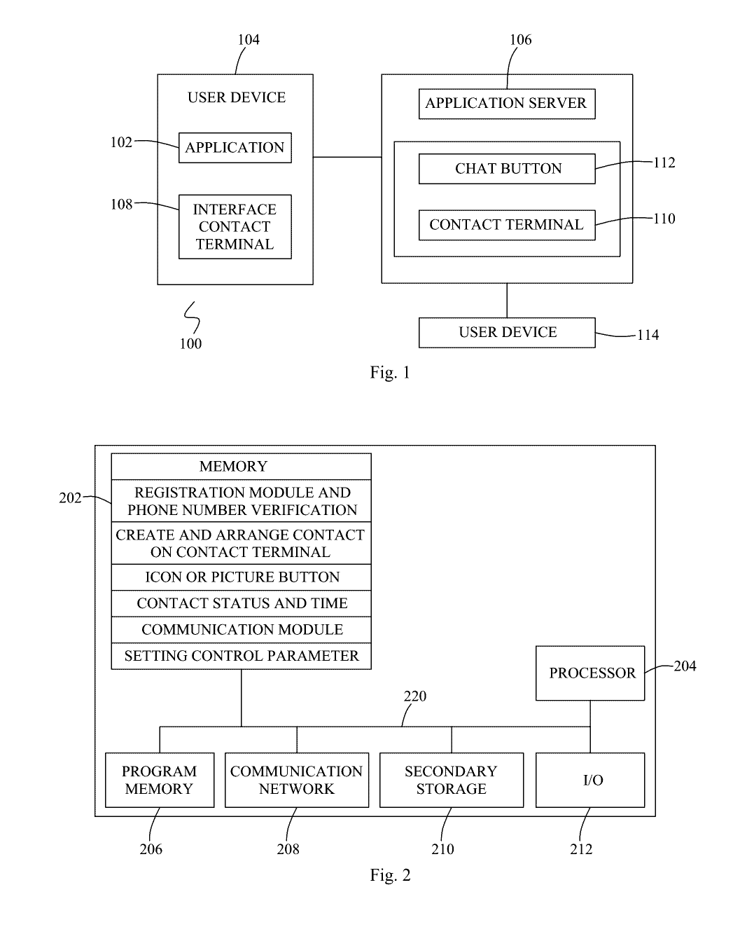

FIG. 1 is a block diagram of a system for facilitating contacts management and communication with real-time status notifications, according to some embodiments of the invention.

In the system 100 shown in FIG. 1, for example, the user downloads an application 102 for a user device 104 (e.g., for a mobile, tablet or the like) from an application server 106. In one particular implementation, for example, the application 102 may comprise an application for a Smartphone on a standardized platform, such as the iPhone, Blackberry or Android platform. In an implementation of a system 100 in which a user can set up a chat button 112.

System 100 is a data center, computer network or other cooperative collection of computer resources for hosting an application 102 that can be simultaneously used by multiple users. In some implementations, the application 102 provides a user with contacts management and communication with voice and text communication from his or her communication device (e.g., user device 102), to/from one or more other users operating other communication devices (e.g., device 114).

The application 102 can synchronize (e.g., automatically or manually) an interface 108 with a contact terminal 110 of the user device 104 and creates a primary chat button 112 for that user. The application 102 may then, for example, request contact configuration on the contact terminal 110, the contact includes contact attributes (e.g., photos, or other customizations). The contact information is then sent to the application server 106, where it is stored as a contact. The contact terminal 110 is returned to the user that created the contact, and is available for communicating with other contacts.

In the implementation shown in FIG. 1, the interface 108 comprises a contact terminal 110 in which contacts are maintained for use on the mobile device. The contact terminal 110 records are copied to an application server 106 as contact terminal records 110 resident on the application server 106. The application server 106 generates chat button 112 for each of the contacts on the interface 108 and sends the generated contact terminal 110 back to the user device 104 for access by the application 102 on the user device 104.

In one particular implementation, the application server 106 creates a chat button 112 for one or more contacts in the user's contact terminal 110. The application server 106 can then send a message to other user devices 114 each of the selected contacts notifying them that the user has created a chat button 112 for their contact information. The application server 106 can also invite the individual contacts to manage their particular chat buttons 112 by downloading an application as described above. Thus, the other user can be invited to sign up with the application server 106 and manage the chat button 114 to edit the chat button 114, add additional information to the chat button 112 or create new chat buttons 112.

If a user is registered with the application 102, the chat button 112 can be seen on the interface 108. And the user can communicate either through a voice or text to the other contacts, the entire group or one or more individual members of the group. Thus, a registered member of the application 102 can accept the chat button 112 to access further communication options that need not be available to non-registered members of the application.

The application 102 hosted by the system 100 is compatible with devices 104, 115 and includes client logic that is executed under the devices' native operating systems. A user operating one type of device and subscribing to one communication server provider can exchange messages with users operating other types of devices and subscribing to other communication service providers. Individual text may be sent to any number of recipients; for example, a group form of communication (e.g., group chat) may be offered in which multiple users interactively exchange instant communications. The voice communication may be placed between one user to another user.

The interface 108 is front-end components of the system 100 that host users' connections with the system and that facilitate the exchange of communications between users. The application server 106 is back end components of the system facilitate maintaining the back end data in exchange of communications between users.

In these embodiments, as part of a user profile retained on the application server 106, identities of other users associated with that user may be identified. These other users will be informed of some or all changes in the user's status (or the changes in the status of the user's device) such as when he/she is available. As described below, other status changes may also be communicated to the associated users.

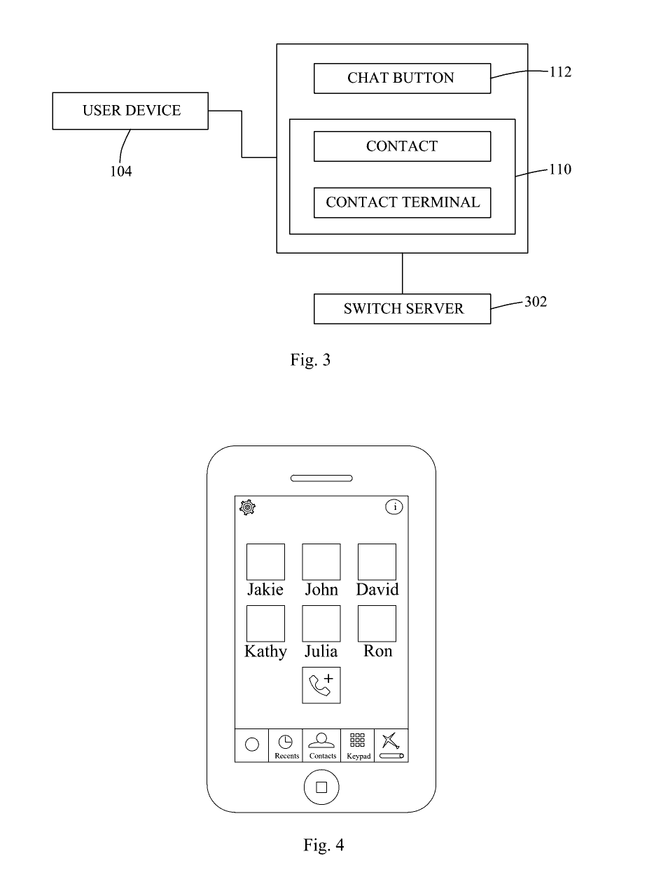

Now refereeing to FIG. 2, is a block diagram in one implementation for performing the system or methods of the present invention. System 100 includes a memory 202 to hold executing programs (typically random access memory (RAM) or writable read-only memory (ROM) such as a flash ROM, a processor 204 for executing instructions, a program memory 206 for holding drivers, a network communication port 208 for data communication, a secondary storage 210 with secondary storage controller for backup/high-availability, and input/output (I/O) ports 212 with I/O controller operatively coupled together over an interconnect 220.

In one implementation, processor 204 executes instructions in memory 202 selected from one or more components including registration module and phone number verification 202a, create and arrange contacts on contact terminal 202b, icon or picture button 202c, contact status and current time 202d, communication module 202e for call or text, and setting, control parameters 202f that manages system resources used when processing one or more of the above components on system 100.

The registration module and phone number verification 202a verifies that a phone number has been provisioned to a mobile device then registers the mobile device on the application server 106 in accordance with implementations of the present invention. One verification module of the present invention retrieves the phone number directly from firmware on the mobile device and performs the verification operations. Alternatively, the user of the mobile device may enter the phone number for the mobile device. Aspects of the present invention first verify that the phone number is registered with the particular mobile device before it can be registered on the system 100 of the present invention.

Create and arrange contacts on contact terminal 202b arrange the plurality of contacts in the contact terminal on the mobile device to a predetermined standard. The contacts are synchronized with registered phone numbers on the system 100 of the present invention. This synchronization continues as new contacts are added to the contact terminal and contacts are added to the system.

Icon or picture button 202c means a specific icon or picture buttons are used for tagging a contact, thereby tagged contacts are displayed on across user screen for simple use by the user tapping on the icon, specifically helping elders or children.

Contact status and current time notification module 202d enables users to update their current status while tracking the status of other users within the system. Further specifies, the current time zone of contacts. Aspects of the present invention also allows the user to determine the status and current time of other user in their contact before initiating a phone call, text message.

Communication module 202e for call or message provides mode of communication with other contacts.

Setting, control parameters 202f provide options to user on the setting icon which will be displayed with the following options: Notifications, Change Button, Contact Sharing, Configure Messages, Cloud Backup, emergency tagging and App Registration/User Data.

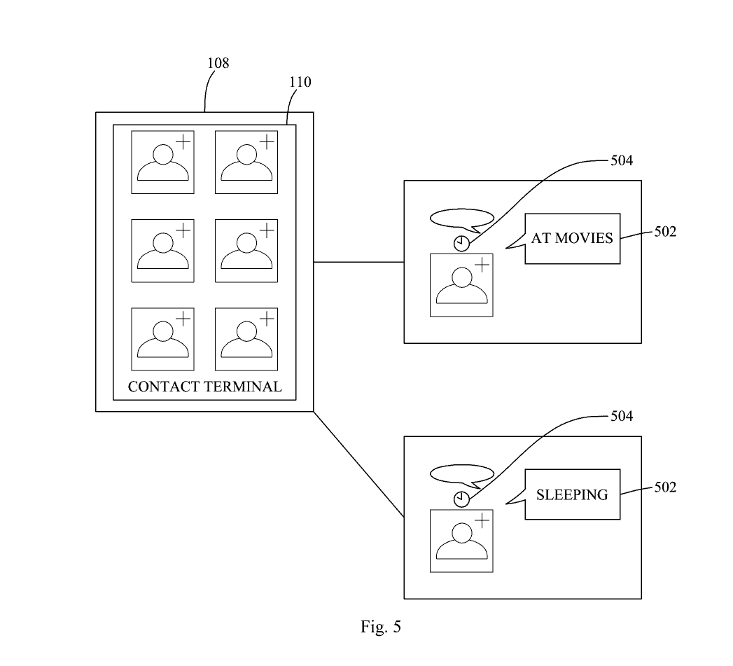

FIG. 3 shows an example implementation of a system 100 for managing chat buttons 112 assigned to a plurality of contacts. In one particular implementation, for example, the chat button 112 maintains mode of communication i.e., call button as well as a message button for each of the plurality of contact. A switch server 302 can retrieve the chat button 112 from the call button to message button. Once the chat button 112 is retrieved, the switch server 302 can obtain the actual target call button details, allowing the phone call or message button for writing a message to be transmitted to the target contact while maintaining total privacy of the target contact. The switch server 302 can route the mode of communication corresponding to the user device originating the communication.

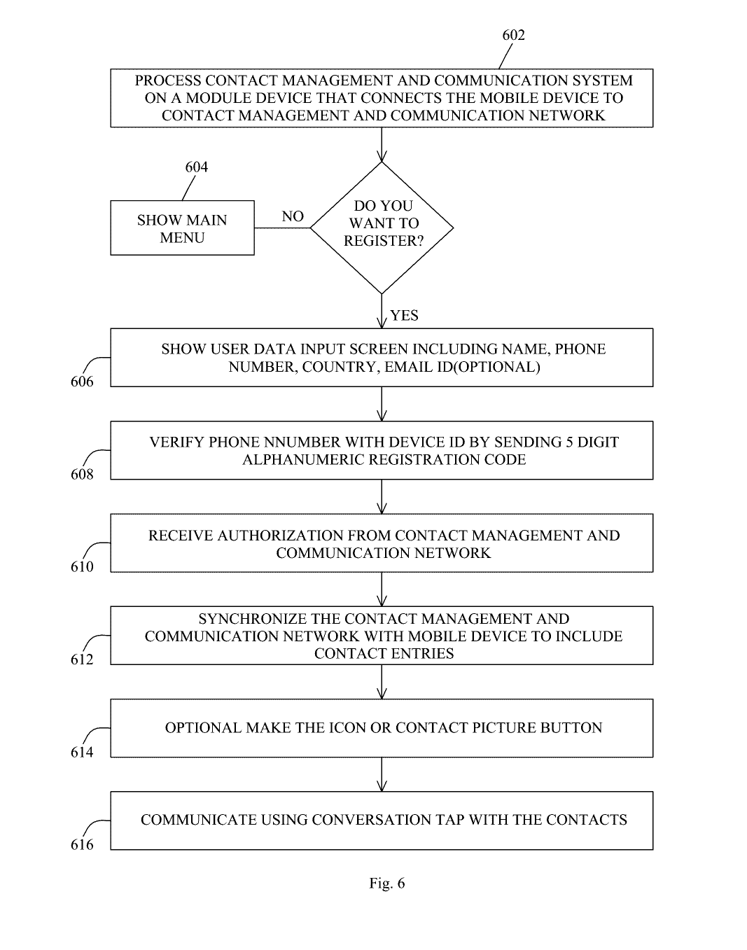

FIG. 4 shows home screen of the user interface 108 that illustrates how plurality of contacts with icon or picture button is arranged on the home screen. The home screen provides various other configurations for quick and easy selection of a contact from plurality of the user's contacts and facilitate communication, followed by quick and easy application selection from a variety of communications modes, including single-click initiation of a communication mode with a default contact or in a default communication mode.

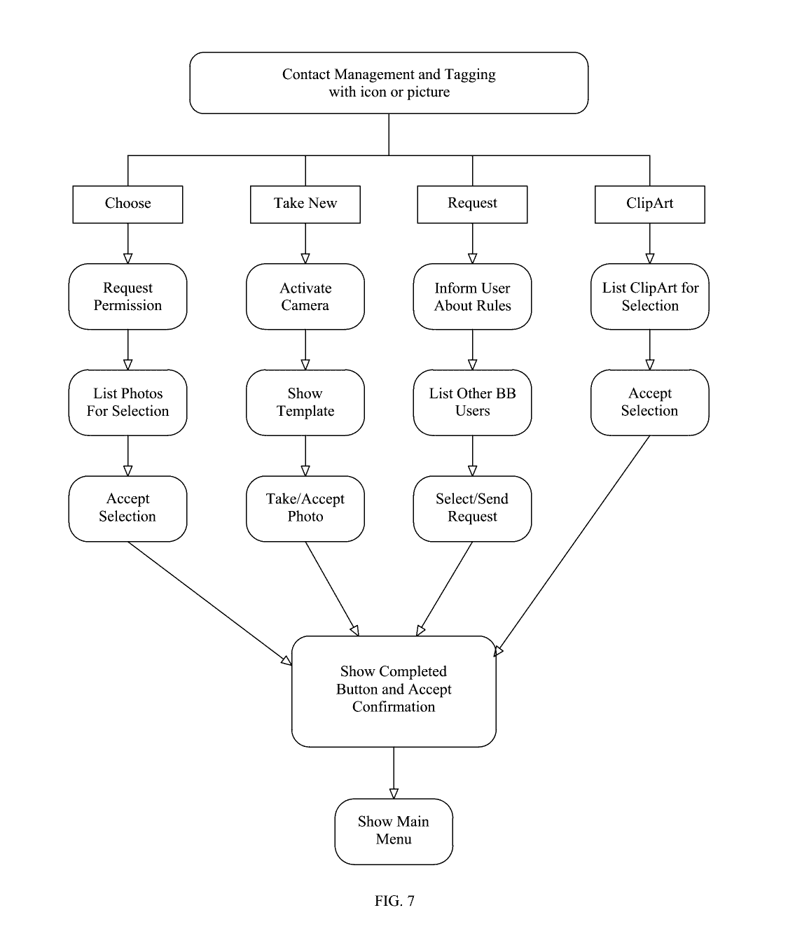

FIG. 5 illustrates a mobile device displaying the user interface 108 in accordance with some embodiments of the present invention. In this example, the interface 108 includes a detailed view of contact terminal 110 of a user displaying status of various contacts and connectivity to some of the other user over a data network. The interface 108 facilitates communication between users on the contact management and communication system 100 as well as ensuring status of the users and their time with respect to their geographic time zone 504.

One implementation of the present invention consistent with the user interface of a mobile device associated with an user device depicts a set of contacts being monitored. A status of the contacts is retrieved and displays the status as indicated by status 502. For example, a user may set the status to indicate a specific activity illustrated in status 502 such as “at movie or sleeping” or may indicate a general status such as status indicating “Busy” or the like. Status on the synthetic communication is flexible and can be set to anything the user wants to indicate.

In some embodiments, the present invention is directed to indicate the current time-zone of users i.e., easy way to indicate the time-zone of all contacts. Because more people communicate across time-zones and also people travel from one time-zone to another more frequently than before. This notification of time of the other contacts to user may sure help to avoid disturbing other contacts at night. It can also help a user to decide whether the contact is available to communicate, for examples “do not disturb”, “airplane mode”, etc. Additionally, the user may be warned while attempting to call a contact in a inconvenient time based on “time zone” and “do not disturb” status of the contact which may automatically record the voice message

Further, depending on the number of contacts, the size and layout of the icon or picture button will change. The Emergency icon or picture button could be named as SOS. The Emergency/SOS button can also be their medical alert button.

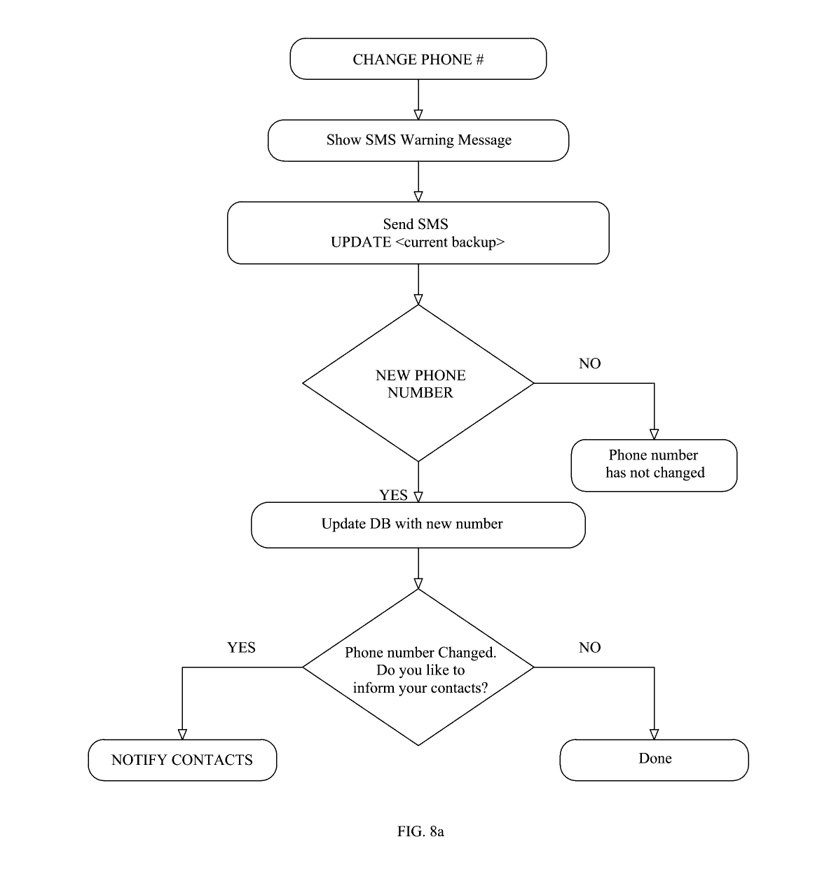

Now referring to FIG. 6 is a flowchart representation of the operations to register the contacts management and communication system 100 using a phone number in accordance with one implementation. The method of registering with the application 102 on the mobile device using a phone number (602) having option to continue with registration or not with yes or not (604). The application 102 performs various operations including registering the phone number and eventually facilitating the communication. The 102 may be downloaded directly through a website accessed by the mobile device or Google play or iPhone app directory over the Internet. In one implementation, the application 102 obtains the phone number and corresponding country code presumed to be associated with the mobile device and used for communications over the contacts management and communication system. The application 102 running on the mobile device may present a series of default options suggesting an international dialing prefix, a country code and a request that the user enter the phone number of the mobile device (606). Typically, these options are suggested by the application 102 based upon the country that the mobile device is currently registered in. However, it is also possible that a user can override these suggested settings and enter their own country code, phone number and other information in the default options.

The verification operation ensures that the phone number originally provided to the application 102 is indeed associated with the mobile device. Conversely, if the phone number was invalid or associated with another mobile device then the verification operation will indicate that the phone number cannot be verified. Verification in one implementation of the present invention confirms the association between the phone number and the mobile device by sending a 6 digit alphanumeric (608).

In one implementation, the verification message may be sent from the application 102 on the mobile device using short messaging service (SMS) on the voice network. A successful return trip of the verification message back to the same contacts management and communication system verifies the phone number in accordance with the present invention (610).

The 102 offers to check if some or all of the phone numbers in a directory on the phone are also registered on the application 102. Accordingly, the contacts management and communication system associated with the mobile device is synchronized with contact entries in the phone directory from the mobile device that are also members of the contacts management and communication system (612).

Once synchronization is complete, in some embodiments, the user can create and arrange the contact as per their preference in different form such family, friend or business (614) and further user can communicate with other users in contact through the application (616). Typical communication between members of the application 102 is done over an internetdata network using their respective normalized phone number. Moreover, users of the application 102 may use the phone number to call or send text messages over the Internet and not pay expensive charges for local and international communication over the data channel of their voice network.

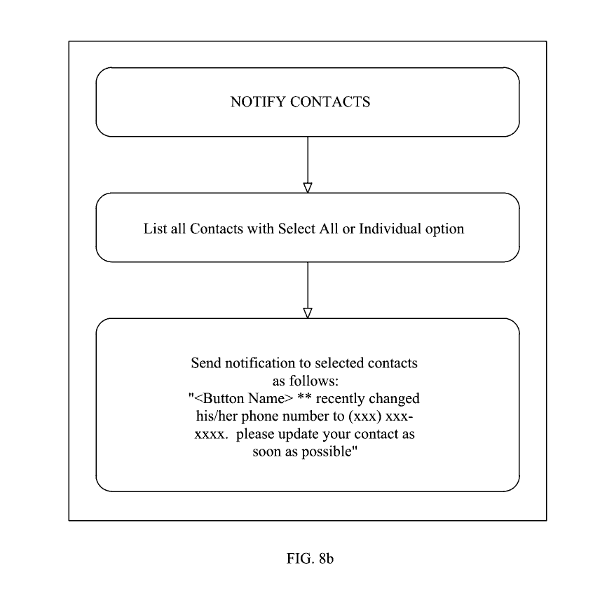

As shown in FIG. 7, the user interface 108 that organizes contacts in multiple groups such as relatives, friends, schoolmates, colleagues, business partners, customers, emergency and healthcare emergency; and specific icon or picture buttons are used for tagging contacts accordingly and tagged contacts are displayed on across user screen for simple use by users specifically by elders, children to facilitate communication to their loved ones/caretakers without accessing confusing Smartphone's native dialing app. User can create an icon or picture with contact's picture or select from hundreds of clipart images. Additionally, a user can even create a clipart for Home, Physician, Dentists, Church, and many more.

From the interface 108, users can communicate with their contact through call or text message. The home screen of the user interface 108 shall have a toggle button that can be switched between “Call mode” to ‘Text mode”. This toggle button will be switched according to user's default communication preference (Call or text). The Emergency icon or picture button will always be there in both modes. Before making a call, the toggle button must be switched to the ‘Call’ mode. When a call button is selected, corresponding number will be dialed. Similarly, before user can send a text, the toggle button must be switched to the ‘Text’ mode. All other buttons will be inactive. When user selects an active button, they will be prompted to select from a list of predefined messages for instant messaging in alphabetical order including ‘Create New’ as an option. User can switch seamlessly from calling mode to text mode with a gentile swipe of finger. Tap to call . . . or Tap to text. No more jumping from one application to another.

Further, a user can create and configure many different instant messages although the system provides for most relevant pre-configured messages, for example “URGENT—please call immediately”, “‘Please call me when you can”, “How are you feeling?”, “Please send me your image for tagging contact”. For Response Messages, there are several pre-configured message for example: “Yes, I will”, “I am busy now”, “Will call you soon”, “I am doing great”, “Thank you” etc.

While at recipient end, the interface 108 shall display a notification with the icon or picture and the name of the individual calling. User has the option to take the call, ignore it, or send a predefined text in response. When user does not answer the call, the interface shall notify the user of the missed call when the interface 108 is opened next time.

When a text message is received, user has the option to respond or ignore it. If user selects to respond, all appropriate response text messages will be displayed for response or the user can opt to create a new text message. When user selects the contacts icon, the interface 108 shall display all the contacts on the screen from the phone's contact list. User can select the appropriate contact to initiate a call or a text message.

The interface 108 provides several setting options to user on the setting icon which will be displayed with the following options: Notifications, Change Button, Contact Sharing, Configure Messages, Cloud Backup, and App Registration/User Data. The notifications are on top of the screen, and user responds or deletes any of these notifications.

The Backup and Restore feature is an important feature of this system. The objective of this feature is to reduce user's data loss and at the same time make it easy for elders and youngsters to use it. The system 100 provides automatically backup of icon picture buttons and custom text messages on the remote server on a nightly basis. At least four previous backups can be stored on the remote server for user information. Backups can be restored from remote server using unique key which consist of six characters. Further, the backup can be restored on different Smartphone devices and with different operator just by using the unique key. Thereby, allowing to merge the backup of icon or picture buttons with existing icon or picture buttons. Also notify users when someone else recovers their backup to protect against hacking.

In various embodiments, the interface 108 of the present invention provides a user to manage contacts, so as to reduce time for finding a contact, increase information processing performance of the mobile terminal, and increase intelligence degree of the mobile terminal.

In some embodiments, a method for arranging contacts and facilitating communication is provided. The method includes the following: arranging contact with icon or picture on home screen of the interface 108 or drag and rearrange icon or picture for contacts on the screen, direct communication through call or text message wherein there is provision to switch from call mode to text mode with a gentle swipe of the toggle button on the screen. The call can be made by tapping on a call button and send text message by tapping on text button. The emergency contacts are tagged in an emergency icon or picture button and emergency icon or picture button is displayed in red color for avoiding confusion; wherein, to make an emergency call by double-taping the icon or picture button tagged as an emergency contact.

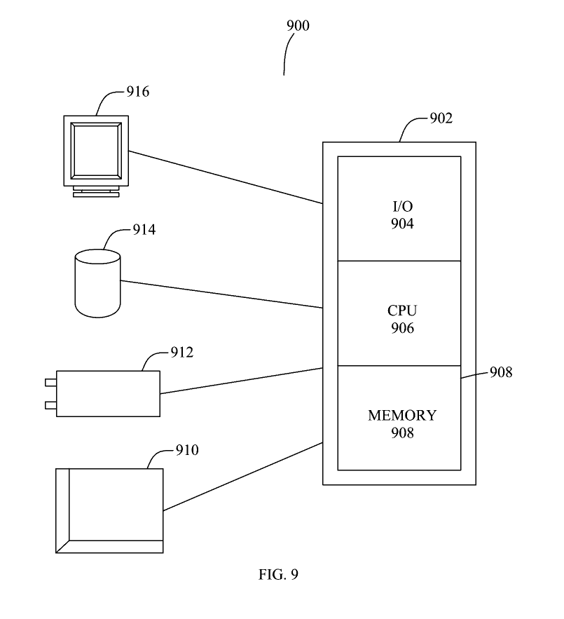

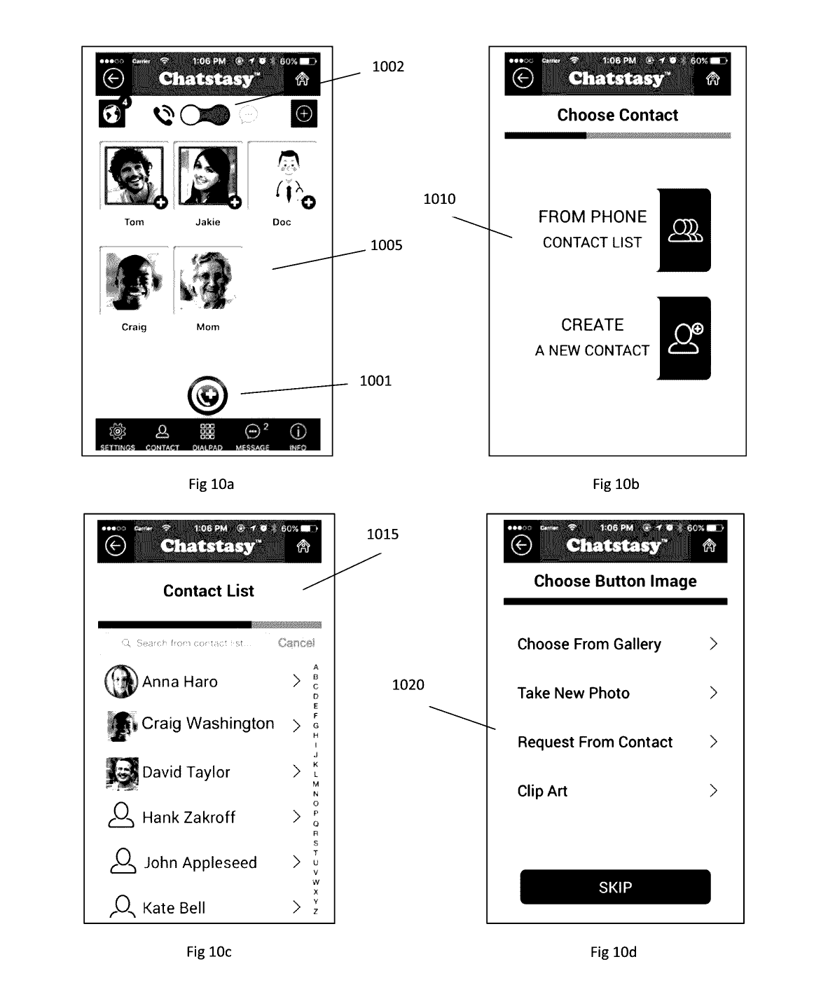

Further, FIG. 8a-8b shows a flowchart for a method of changing phone number and providing update notification to other contacts in the event of a phone number change. i.e., the ability to receive number change notification from other users; and the ability to automatically change the contact number to the new number. The system 100 provides the ability to dynamically update the other contents from the administrator panel such as: terms of user agreement; privacy policy document; World Emergency Numbers; Clipart images; System Default Messages; ‘Frequently Asked Questions (FAQ)’ page etc. Also, it has ability to send custom notification to users along with system update and most preferably the update notification is sent between 8 pm to 8 am of user's local time to avoid any disturbance to users.

A un-registered user can perform many functions including but not limited to Add Contact Buttons, Tag Contact Buttons as an Emergency Contact, Configure Main Emergency Button, Access World Emergency Numbers, Access Phone Contacts and make calls, Invite Phone Contacts via Email or SMS, Share on Social Media, Make Calls Using Dial pad.

A registered user can perform including but not limited to Auto Identification of Other user, Send and Receive Text Messages, Send and Receive Button Images, Cloud Backup and Restore, Contact Sharing, Configure Custom Text Messages, Auto Population of User's Default Country's Emergency Number, Double-Tap Emergency Calling, Notify Contacts of Phone Number Change, Auto Update of Contact's Phone Number Changes. More particularly but not exclusively, the present invention relates to systems and methods for adding and updating personal information in personal management systems, both online and contained within Smartphone.

Again, the system 100 for managing contacts and facilitating communication is provided. The system includes the following: one or more processors; a memory; and one or more program modules stored in the memory and to be executed by the one or more processors; the one or more program modules comprise the following: a contact terminal 110, adapted to obtain a plurality of contacts, wherein the contacts are arranged with preference of the user and tagged with icon or picture button; a priority configuring module, adapted to respectively configure a priority for each of the at least one contact; a second communication terminal module, adapted to facilitate communication through call mode or text mode.

The contact terminal 110 store contact information is obtained according to static information of the contacts from a local address book. The contact terminal is configured to update the static information of the contacts in real time. The static information of the contact comprises at least one of: name, number, subscribed location, operator that the number belongs to, and contact relationship group. The contacts information is on home screen, the contacts are stored as relatives, friends, schoolmates, colleagues, business partners, customers, emergency and other individuals. Since the contacts are on home screen with icon or picture button, it facilitates the user to find the contact rapidly, reduces time for finding the contact.

Further, the system 100 may includes a network module for coupling the application 102 to the Internet and to one or more telephony communication networks, a database, and an application server 106 configured to: communicate with other plurality of Smartphone users through the network to receive a set of contact information for a user. Said contact information updates for user, update a contact terminal record 112 in the database, and transmit said updated contact record 112 to user interface 108 for synchronization with the already available contact information.

In some embodiments, a method of facilitating contact backup with the user interface 108 in Smartphone, comprising retrieving a set of contact information stored on said user interface 108, generating a synchronization file including the set of contact information, and transmitting the synchronization file to a remote server, wherein the contact information is stored in a database of said remote server.

In some embodiments, a method for providing contact location information, comprising receiving from the user interface 108 of first user at remote server location information for a first user, selecting the user interface 108 associated with a second user to receive said location information, and sending said location information from said remote server to said second user.

In some embodiments, a method of communications, comprising receiving at a remote server, from a first user, a request to communicate with a second user based by tapping on icon or picture button of said second user, determining contact information for said first user and said second user, and providing a bridged connection between said first user and said second user.

As stated above, the user interface 108 for a Smartphone can be used to facilitate communications by a user. A user selects a contact from plurality of the user's contacts. Once the contacts are configured, a minimal number of navigation/selection features is necessary to activate any number of communication modes available to the contacts. The contacts are configured such that simple and quick navigation between the contact members is achieved. The contacts can be presented in two dimensional and three dimensional arrangements, and in any number of list or geometric configurations. Also, a provision of Airplane mode to activate/deactivate the system from sending/receiving calls or messages is provided.

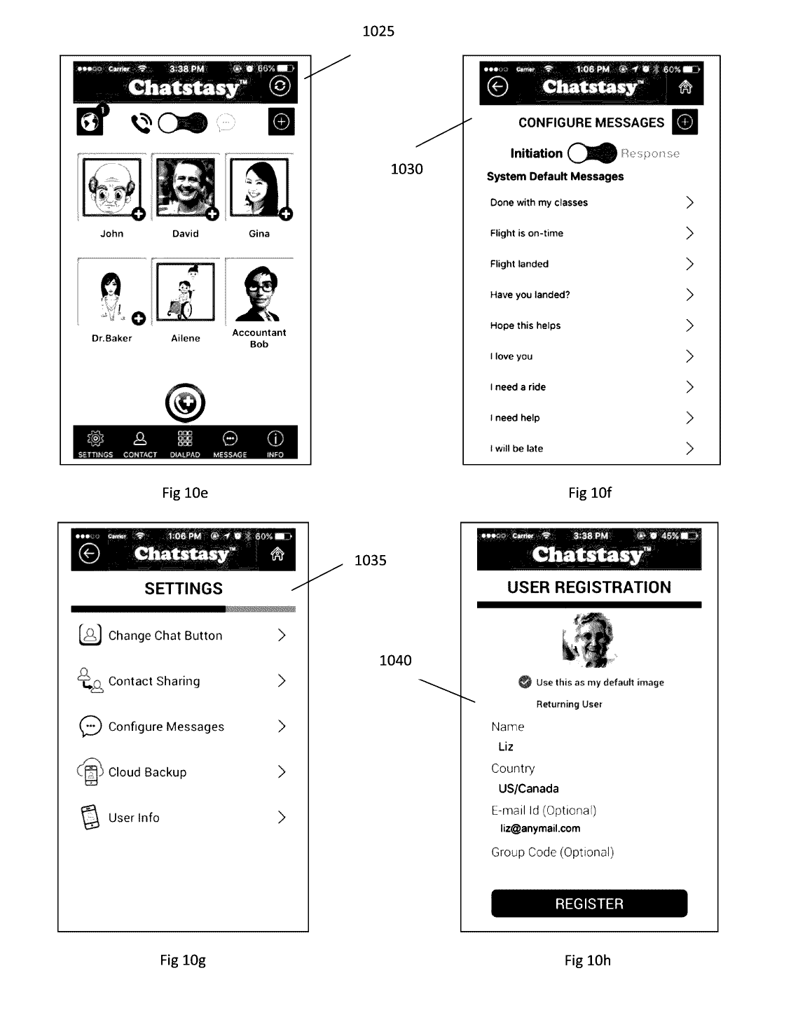

FIG. 9 illustrates an exemplary system useful in implementations of the described technology. A general purpose computer system 900 is capable of executing a computer program product to execute a computer process. Data and program files may be input to the computer system 900, which reads the files and executes the programs therein. Some of the elements of a general purpose computer system 900 are shown in FIG. 9 wherein a processor 902 is shown having an input/output (I/O) section 904, a Central Processing Unit (CPU) 906, and a memory section 908.

The computer system 900 may be a conventional computer. The described technology is optionally implemented in software devices loaded in memory 908, stored in a data base 914, and/or communicated via a wired or wireless network link, thereby transforming the computer system 900 in FIG. 9 into a special purpose machine for implementing the described operations.

The I/O section 904 is connected to one or more user-interface devices such as a display unit 916 and a database 914. Computer program products containing mechanisms to effectuate the systems and methods in accordance with the described technology, the programs and data may reside in the memory section 910. The network adapter 912 is capable of connecting the computer system to a network via the network link, through which the computer system can receive instructions and data. It is appreciated that the network connections shown are exemplary and other means of and communications devices for establishing a communications link between the computers may be used.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

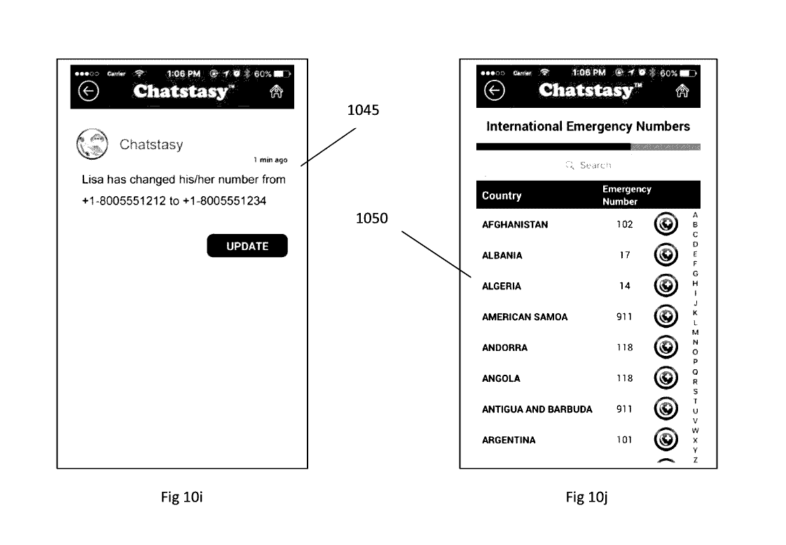

FIGS. 10a-10j are screenshots of an example of the user interface 108 of contacts management and communication system. These screenshots are merely for exemplary illustrative of the invention and changes can be made without departing from the scope of the claims. As illustrated in FIG. 10a-10e are screenshots of the user interface 108, which illustrates a method of arranging and tagging contacts in steps. An add button on screenshot 1005 is for adding contacts which are either by retrieved contact from a local address book or creating a new contact as shown in screenshot 1010. Screenshot 1015 is the list of contacts to be selected by user, once a contact is selected; the image can be chosen either from gallery or clip art or through a request for an image to the contact or by taking photo by Smartphone camera itself which is illustrated in screenshot 1020. The screenshot 1025 shows that a new contact is arranged in the contact list and an icon or picture button is created for the new contact. The emergency contacts are pre-tagged in emergency icon or picture button according to the country of origin and also a list of emergency numbers for all countries are pre-configured. The screenshot 1005 shows an emergency dialing tap 1001, the current location of the caller is retrieved and displayed to help notify emergency personnel. The emergency contacts are automatically or dynamically updated in case of any change in number and for new number. Further, in the screenshot 1005 shows the home screen of the user interface 108 shall have a toggle button 1002 that can be switched between “Call mode” to ‘Text mode”. This toggle button 1002 will be switched according to user's default communication preference (Call or text). Before making a call, the toggle button 1002 must be switched to the ‘Call’ mode. When a call button is selected, corresponding number will be dialed. Similarly, before user can send a text, the toggle button 1002 must be switched to the ‘Text’ mode. All other buttons will be inactive.

FIG. 10f illustrates some of pre-configured text message which will be used by a user to send instant message to a contact by just taping contact icon or picture button. Screenshot 1030 provides an option for initiating text message or response of text message received and screenshot 1030 shows a list of preconfigured text messages. Moreover, the user interface has the ability to store and send frequently used messages with ease.

FIG. 10g is a screenshot of the user interface 108; screenshot 1035 illustrates registration in the application contact management and communication as described in various embodiments of the invention.

FIG. 10h is a screenshot 1040 of the user interface, screenshot 1040 illustrates different setting options for user for assisting in contact management and communication as described in various embodiments of the invention.

FIG. 10i is a screenshot 1045 of the user interface 108 showing phone number change notification and providing update notification to other contacts in the event of a phone number change. i.e., the ability to receive number change notification from other users.

FIG. 10j is a screenshot of the user interface 108, screenshot 1050 shows list of emergency number across the world. The emergency contacts are pre-tagged in emergency icon or picture button according to the country of origin and also a list of emergency numbers for all countries are pre-configured.

One advantage of the present invention is its ability to take minimal information from users to perform registration that is for registration user mobile number is not required, uses of Short Messaging Service (SMS) to fetch user's mobile number including country code; use of 6-digit alphanumeric key to uniquely match user registration with SMS message and direct network connectivity.

One other advantage of the present invention is its ability to indicate the current time-zone of users i.e., easy way to indicate the time-zone of all contacts. When activated, a small time clock will be displayed on the chat button to indicate the time at the location of the user. This clock will be shown in 5 min interval and will update upon taping the refresh button.

One other advantage of the present invention is its ability to view the current status of other contacts, as well as allow other contacts to view the current status of the user. Also, every user can customize the status with predefined text to be viewed by contacts.

One other advantage of the present invention is its ability to share picture, video and other media between users as well as allow for faster capture and download of information such as text, photographs, video clips, or other media. Accordingly, allows for capturing, organizing, updating and displaying such as personal and contact information, along with associated data.

One other advantage of the present invention is its ability to send pre-configured text messages to other users. In the same way, the user can create and save text message in many languages; and send pre-configured text messages to other users as required in text messaging.

One other aspect of the present invention is the ability to tag contacts for emergency to make a call to emergency personnel during need such as ability to make an emergency call to summon ambulance service. Further, the interface automatically notifies all ICE contacts with location of the user in case of emergency. The interface provides an emergency chat button on each tab screen display to summon an emergency help that could save a life, where location of the user is automatically retrieved and automatically changes the emergency number based on the location or country the user is registered. Where location of the user is automatically retrieved and automatically changes the emergency number based on the location or country the user is registered.

One other advantage of the present invention is to automatically backup and manually back on the remote server of user related data such message, picture and other media. Also notify users when someone else recovers their backup.

One other advantage of the present invention is its ability to identify returning users of the system during registration; and accordingly inform and recover cloud backup of the returning user.

The Backup and Restore feature is an important feature of this system. The objective of this feature is to reduce user's data loss and at the same time make it easy for seniors and youngsters to use it. The system provides automatically backup of icon picture buttons and custom messages on the remote server on a nightly basis. At least four previous backups can be stored on the remote server for user information. Backups can be restored from remote server using unique key which consist of six characters. Further, the backup can be restored on different Smartphone devices and with different operator just by using the unique key. Thereby, allowing to merge the backup of icon or picture buttons with existing icon or picture buttons. Also notify users when someone else recovers their backup to protect against hacking.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure.

We claim:

1. A user interface for contact management and communication on mobile devices, comprising:
a contact terminal for creating and arranging a plurality of contacts on a home tab screen display;
creating a chat button that may be used to identify a contact on the contact terminal;
a communication button for ease of communication configured with the chat button for each contact; and
a selectable control displayed on the home tab screen display;
wherein the chat button includes contacts and their attributes not limited to picture, location, current status, language preference and current time zone, further the contacts and their attributes are tagged with the chat button on the home tab screen for ease of communication just by tapping the chat button,
wherein selection of the control in a first context initiates a call toward the selected contact; and
wherein selection of the control in a second context initiates transmission of a textual message toward the selected contact,
wherein the communication button enable user for switching from call mode to text mode with a gentle swipe of the selectable control.

2. The user interface of claim 1, wherein the mobile devices are like in example a Smartphone, a tablet PC, a iWatch or a personal computer, comprising a software application (App) that enables users to access to a application server by internet and to interact with other users belonging to the same application server that have been previously registered through a registration process.

3. A user interface of claim 1, wherein the contact terminal provides the chat button on home tab screen display that is a simple, convenient way to identify a contact for specific purpose or in specific condition based on attributes and extracted conveniently and quickly in the course of communicating from list of plurality of contacts.

4. A user interface of claim 1, wherein the contact terminal provides an ability to create groups for more than two users and providing text messaging and calling facility to multiple users of a pre-configured selected group.

5. A user interface of claim 1, wherein the contact terminal arranges the contact and their attributes on across the home tab screen display for simple use by the user tapping on the chat button, specifically helping elders or children, and the user may be warned while attempting to call a contact in a inconvenient time based on “time zone” and “do not disturb” status of the contact, and automatically record the voice message.

6. A user interfaces of claim 1, wherein the plurality of contacts is registered and displayed on home tab screen display, further when a new user is registered, the chat button of registered user will automatically come-up with different color such as in blue color and also the VOIP calling over data network is automatically activated, and the user can set their preferences for ease of communication between VOIP calling and a conventional call.

7. A user interface of claim 1, wherein the communication button initiates an emergency text notification in addition placing a call; the user at the receiving end will be able to see the emergency text message and location of the sender before picking the call.

8. A user interface of claim 1, wherein the user may be able to create a message (voice or text) in any language and schedule it for delivery at a specific date/time, also able to edit or rerecord the message at any time before the scheduled time.

9. A user interface of claim 1, wherein the chat button further indicates the current time-zone of the contacts to avoid disturbing other contacts when the contact is not available for communication and also the user may leave a voice message without disturbing the receiving user.

10. A user interface of claim 1, wherein the user interface further provides update notification to other contacts in the event of a phone number change, where the user may notify selected contacts and the receiving user may update the changed number in the chat button.

11. A user interfaces of claim 1, wherein the interface has an ability to send and receive the chat button image from the contacts, additionally provides setting of the chat button image of based on user's profile avatars for different group where if one of the contact in the group creates chat button image, the chat button image will be automatically populated as default image for the group.

12. A user interface of claim 1, wherein the interface further provides an emergency chat button on each tab screen display to summon an emergency help that could save a life, where location of the user is automatically retrieved and automatically changes the emergency number based on the location or country the user is registered.

13. A user interfaces of claim 1, wherein the interface automatically notifies all In Case of Emergency (ICE) contacts with location of the user when the emergency button is pressed.

14. A method of contact management and communication on mobile devices, comprising:
arranging a plurality of contacts on a contact terminal on a home tab screen display;
creating a chat button that may be used to identify a contact on the contact terminal;
initiating a communication button for ease of communication configured with the chat button for each contact, and
using a selectable control displayed on the home tab screen display;
upon selection of the control in a first context initiating a call toward the selected contact; and
upon selection of the control in a second context initiating transmission of a textual message toward the selected contact.

15. The method of claim 14, wherein the contact terminal arranges the contact and their attributes on across the home tab screen display for simple use by the user tapping on the chat button, specifically helping elders or children, and the user may be warned while attempting to call a contact in a inconvenient time based on “time zone” and “do not disturb” status of the contact, and automatically record the voice message.

16. The method of claim 14, wherein the communication comprises a voice over Internet Protocol (VOIP) communication, conventional calling and textual messaging.

17. The method of claim 14, wherein the communication may automatically switch between using VOIP and Native Calling mode based on chat button type and status.

18. The method of claim 14, wherein for the communication, a user may create and store custom messages in any language for later use.

19. The method of claim 14, wherein the contact is configurable by the user.

20. The method of claim 14, wherein the contact is configurable by the user and to be accessible directly on the home tab screen display.

21. A user interface for contact management and communication on mobile devices by, comprising:
a memory; and
a processor, coupled to the memory, adapted to:
receive a request to connect the mobile device to an application server;
verify an association between the normalized phone number and the user interface via a loop back verification message;
receive authorization for the mobile device to communicate over the application server;
configure a plurality of contacts in the contact terminal on home tab screen display,
create a chat button that may be used to identify a contact on the contact terminal;
a communication button for ease of communication configured with the chat button for each contact; and
a selectable control displayed on the home tab screen display;
wherein selection of the control in a first context initiates a call toward the selected contact; and
wherein selection of the control in a second context initiates transmission of a textual message toward the selected contact.
